(19) United States
(12) Patent Application Publication
(10) Pub. No.: US 2024/0430156 A1
(43) Pub. Date: Dec. 26, 2024

(54) DEVICE, NETWORK, METHOD AND COMPUTER PROGRAM FOR CONFIGURING A DISTRIBUTED INTELLIGENCE NETWORK

(71) Applicant: SIGNIFY HOLDING B.V., EINDHOVEN (NL)

(72) Inventors: PETER DEIXLER, ARLINGTON, MA (US); BOZENA ERDMANN, AACHEN (DE); LEENDERT TEUNIS ROZENDAAL, VALKENSWAARD (NL)

(21) Appl. No.: 18/274,003

(22) PCT Filed: Jan. 13, 2022
(86) PCT No.: PCT/EP2022/050604

§ 371 Date: Jul. 25, 2023

Related U.S. Application Data
(60) Provisional application No. 63/141,102, filed on Jan. 25, 2021.

(30) Foreign Application Priority Data
Feb. 4, 2021 (EP) 21155133.8

(51) Int. Cl. H04L 41/0806; H04L 12/28; H04L 12/66; H04L 43/06

(52) U.S. Cl. CPC H04L 41/0806; H04L 12/283; H04L 12/66; H04L 43/06

(57) ABSTRACT

The invention refers to a network device (110) for configuring a network (100) to enable the network to work with a gateway device (130). The gateway device is adapted to act as gateway within the network when the gateway device is present in the network, wherein during the configuration the gateway device is absent from the network. The network device is adapted to provide information indicative of characteristics of the network and relevant for a gateway device, to store the information such that the gateway device can access the information, and to configure the network based on the information such that the gateway device can act as a gateway when present in the network, wherein the network is configured as if the gateway device were present in the network. Thus, the utilizing of a gateway device not used for the installation of the network can be simplified.

### FIELD OF THE INVENTION

The invention relates to a device, a network comprising the device, a method and a computer program for configuring a distributed intelligence network to enable the network to work together with an ephemeral gateway device.

### BACKGROUND OF THE INVENTION

Today standalone home or office automation and control systems like intelligent lighting systems are becoming popular, both in consumer and in professional space. During the installation of such a system, the system is provided with a certain set of rules that allows the system to autonomously manage and control the home or office application for which it is intended. However, in many cases the need arises to reconfigure the system or to provide new software to the system. For this, most home or office application network systems are provided with a fixed gateway, i.e. a device being permanently part of the network that allows the network to connect to the internet or to other networks in the vicinity of the system. However, if the network refers to a distributed intelligence network, i.e. a network in which tasks referring to the control and functioning of the network are distributed between all network devices without fixed assignments of tasks to specific network devices, it is often difficult to provide one device with a capability to form a fixed gateway. In this context, for the configuration often an ephemeral gateway is connected to the distributed intelligence network. Such an ephemeral gateway is known to the system and can be connected and disconnected to/from the system to act as a gateway whenever necessary. However, introducing a new ephemeral gateway device to the network is often time-consuming, difficult or even needs the presence of the ephemeral gateway device used for installing the network during the installation process. Thus, there is a need for providing the possibility to allow the system to work together with an ephemeral gateway device that was not present at the time of the installation or previous configuration of the distributed intelligence network.

### SUMMARY OF THE INVENTION

It is an object of the present invention to provide a device, a network comprising the device, a method and a computer program that allow simplifying the usage of an ephemeral gateway device with the distributed intelligence network that differs from the ephemeral gateway device used during the installation of the distributed intelligence network. In a first aspect of the invention a network configuration device for configuring a distributed intelligence network to enable the network to work together with an ephemeral gateway device is presented, wherein the ephemeral gateway device is adapted to act as a gateway within the network when the ephemeral gateway device is present in the network, wherein during the configuration the ephemeral gateway device is absent from the network, wherein the network configuration device comprises a) a network information providing unit for providing network information indicative of characteristics of the network, wherein the network information is relevant for a gateway device for performing its tasks as a gateway in the network, b) an information storing unit for storing the network information such that the ephemeral gateway device can access the network information for the purpose of performing its task as a gateway for the network, and c) a configuration unit for configuring the network based on the network information such that the ephemeral gateway device can act as a gateway when present in the network, wherein the network is configured as if the ephemeral gateway device were present in the network.

Since the information storing unit stores the network information such that the ephemeral gateway device can access the information for the purpose of joining the network and acting as a gateway, the ephemeral gateway device can directly access the information and join the network without having first to negotiate with the network over the providing of the information. Moreover, since the configuration unit is adapted to configure the network based on the network information such that the ephemeral gateway device can act as a gateway when present in the network, wherein the network is configured as if the ephemeral gateway device were present in the network, if after the configuration with the configuration unit the ephemeral gateway device joins the network, the network is already configured and the ephemeral gateway device can directly start to act as a gateway for the network without having to first configure the network for its task. Accordingly, a time-consuming and complicated installation process of the ephemeral gateway device as a gateway in the network can be omitted and the ephemeral gateway device can directly be used together with the network. Thus, the utilizing of an ephemeral gateway device that was not used for the installation of the network can be simplified.

The network configuration device is adapted to configure a distributed intelligence network to enable the network to work together with an ephemeral gateway device, wherein the ephemeral gateway device is adapted to act as a gateway within the network when the ephemeral gateway device is present in the network. In particular, during the configuration by the network configuration device, the ephemeral gateway device is absent from the network. Moreover, the network configuration device can also be adapted to configure the distributed intelligence network to enable the network to work together with more than one, preferably a plurality of different, ephemeral gateway devices that can preferably be used concurrently with the distributed intelligence network.

The network configuration device can be any device, for instance, a standalone device that is adapted for configuring a distributed intelligence network. Alternatively, the network configuration device can be a part of another device, for instance, of a smartphone, a personal computer, a laptop, a user interface, etc. Moreover, for the configuration of a distributed intelligence network also a plurality of network configuration devices can be used in parallel. Additionally or alternatively, the functions provided by the network configuration device can also be distributed over a plurality of standalone devices that together then form the network configuration device.

Generally, a network has three basic functionalities spread over the devices, a sensing functionality, a control functionality and an actuator functionality. A controlling functionality can be provided by sensors or switches provided in the network, can be provided by one or more actuators of the network, like lighting devices, or can be provided by a dedicated device, like a hub/gateway device, whereby this hub/gateway device can provide the intelligence by itself or by communicating with e.g. a device in the cloud. The latter possibility refers to a centralized control architecture, since all events are managed by the central dedicated device. For instance, in such a centralized system, sensor events go to the central device, and the central device determines which lights need to be controlled. A distributed network refers to networks in which no such central control function is provided and a dedicated central device is omitted.

A distributed intelligence network refers to a network that is configured to share network tasks, like the control of the functional tasks of the network, between some or all network devices being part of the network. In particular, a distributed intelligence network does not comprise fixed assignments of tasks to specific network devices of the network. The term “intelligence” in this context indicates that the distributed intelligence network is adapted to reassign tasks of the network between the network devices based on the circumstances. For instance, if a first network device is assigned with a task of controlling a communication between the network devices, but suddenly the communication between the first network device with the rest of the network devices is disturbed, this task of controlling the communication can be provided to a second network device which in this situation provides a better communication between all network devices. Thus, generally, distributed intelligence networks do also not comprise a central and fixed gateway device that provides communication between the network and, for instance, the internet.

Generally, a gateway refers to a device that is configured to allow a network to communicate with another network, like the internet, another network in the area, an internal or external cloud storage, etc., wherein the communication of the network with the other network is provided and controlled by the gateway. The communication possibility between the networks provided by the gateway can be a “direct” communication, in which the gateway is connected to the two networks at the same time, or an “indirect” communication in which the gateway connects to the two networks at different times such that the communication between the networks in this case is time shifted by the gateway. For example, the gateway can first connect to a first network and receive a message for a second network and then disconnect from the first network. After some time the gateway can then connect to the second network and deliver the message of the first network to the second network. Preferably, the gateway device is adapted to provide a direct communication between two networks by being connected to two networks at the same time. An ephemeral gateway device then refers to a gateway device that is not permanently present in the network, but can be connected to the network in case the task of a gateway is necessary for the network. The ephemeral gateway device can then be disconnected if this task is not needed anymore. The ephemeral gateway device can be any device that provides the respective functionality. Preferably, the ephemeral gateway device is part of a handheld and portable computer device providing a connection capability to other networks, like the internet. For instance, the ephemeral gateway device can be represented by an application installed on a smart phone, a tablet, a laptop, a user interface, etc.

The network information providing unit is adapted to provide network information indicative of characteristics of the network. The network information providing unit can be a storing unit on which the network information is stored and from which the network information can be retrieved. Also, the network information providing unit can be a retrieving unit for retrieving the network information from, for instance, at least one network device being part of the network which should be configured, wherein the network information providing unit is then adapted to provide the received network information. Moreover, the network information providing unit can also receive the network information as input from a user, for instance, via a user interface and can then be adapted to provide the received network information. The network information refers to information on the network that is relevant for a gateway device for performing its task as a gateway in the network. In particular, the network information can comprise information on network credentials, network addresses, information on the network devices, information on a grouping of the network, information on security measures of the network, information on the permission given to an ephemeral gateway device, etc.

The information storing unit, which can also be regarded as an information storage controller, is adapted to store the network information such that the ephemeral gateway device can access the information for the purpose of acting as a gateway in the network. In particular, the information storing unit can be adapted to store the network information such that the ephemeral gateway device can access the information before and/or after joining the network. In particular, network information necessary for joining the network can be stored such that the ephemeral gateway device can access the information before joining the network and information usable for the task as a gateway can be stored such that the ephemeral gateway device can access this information after having joined the network. For instance, the information storing unit can be adapted to store the network information on an external storage or an internal storage of the network or can be adapted to distribute the network information in the network, for instance, based on the storage capabilities of the network devices. In a preferred embodiment, the information storing unit is adapted to store the network information in a virtual cloud storage such that the ephemeral gateway device can access the information in the virtual cloud storage for the purpose of acting as a gateway for the network. A virtual cloud storage refers to a computational storage that is external to the distributed intelligence network and can be accessed by a plurality of devices, inter alia, by the ephemeral gateway device. The virtual cloud storage can refer to a computational storage that is provided on-site, in particular, in the same building or by the same company as the distributed intelligence network, for instance, providing a storage service that can only be accessed by inhabitants of the building or employees of the company. However, the virtual cloud storage can also be a storage provided in a global network, like the internet, that can be accessed by a plurality of users.

In another preferred embodiment, the information storing unit is adapted to store at least network information that is different from the data necessary for the ephemeral gateway device to access the network on at least one network device of the network. For instance, information like a security measure that is necessary for the ephemeral gateway device for joining the network can be stored by the information storing unit in the virtual cloud storage or in any other external storage such that the ephemeral gateway device can access the information before joining the network. However, other network information that is relevant for the ephemeral gateway device for performing its task as a gateway, like network device addresses, network device groupings, etc., that are not necessary for joining the network can be stored by the information storing unit in the storage of at least one network device of the network such that the ephemeral gateway device can access this part of the network information after it has joined the network. In a preferred embodiment, the information storing unit is adapted to store the network information by distributing the network information to different network devices based on the network information. For instance, the network information can comprise information with regard to the storing capabilities or the communication bandwidths of the network devices of the network and the information storing unit can be adapted to distribute the network information to the different network devices for storage based on this network device information. In particular, the information storing unit can be adapted to store more network information on network devices comprising a higher storage capability, a higher communication bandwidth, more connections to other network devices, etc., than the other network devices of the network. In such an embodiment, the ephemeral gateway device can then use the network information stored external of the network for joining the network and can then search the network devices themselves for the other information relevant for performing its task as a gateway in the network. Preferably, in this case the information storing unit is adapted to store information on the distribution of the network information on only one specific network device or externally of the network such that the information on the distribution of the network information can easily be accessed by the ephemeral gateway device before or after having joined the network.

The configuration unit is adapted to configure the network based on the network information such that the ephemeral gateway device can act as a gateway when present in the network, wherein the network is configured as if the ephemeral gateway device were present in the network. In particular, the configuration unit can use the network information for preparing one or more of the network devices to allow contact of an ephemeral gateway device or can configure the security measures of the network such that an ephemeral gateway device, for instance, a specific ephemeral gateway device, is allowed to join the network. In particular, the network is configured as if the ephemeral gateway device were present in the network, i.e. as if the ephemeral gateway device had already joined the network. For instance, the configuration unit can in this case simulate to be the ephemeral gateway device or generally act as an ephemeral gateway device during the configuration. Preferably, for simulating the ephemeral gateway device the configuration unit can be provided with information about the ephemeral gateway device that is not present, for instance, via a connection to a storage device storing this information, like a cloud storage, or by input of a user of the configuration device. The information can refer to an identity of the ephemeral gateway device, information on a user of the ephemeral gateway device, credentials of the ephemeral gateway device, etc. Moreover, the configuration unit can be adapted to implement ephemeral gateway device information that refers to specific behaviors expected by the ephemeral gateway device of a network device, preferably a possible proxy device. These specific behaviors can refer to specific beacon patterns, advertisements, etc. and can also be part of the information on the ephemeral gateway device.

Preferably, the configuration unit is adapted to configure the network based on the network information such that more than one ephemeral gateway device can act as a gateway when present in the network, in particular, when present concurrently in the network. Also in this case the network is configured as if the more than one ephemeral gateway devices were present in the network. In this case the configuration unit can be, for instance, adapted to configure the network by defining access rights, permission, assignments between network devices and ephemeral gateway devices, etc., for the different ephemeral gateway devices.

In an embodiment, the configuration unit is adapted to configure a reporting functionality of the network such that the network carries out the reporting functionality as if the ephemeral gateway device were present in the network. A reporting functionality can refer to any functionality that includes reporting information from one or more network devices of the network to the gateway, wherein the gateway can then provide this reported information to other networks, like the internet, a management network in the facility for managing the functions of different networks, another network near the network, etc. In particular, the network, i.e. the network devices, carries out the reporting functionality as if the ephemeral gateway device were present in the network. Thus, the network devices provide the reports, for instance, to a specific network address that refers to the network address the ephemeral gateway device occupies when present in the network, or the network devices broadcast or multicast the reports and assume that the ephemeral gateway device is present in the network for receiving the reports.

In a preferred embodiment, the configuration of the reporting functionality as if the ephemeral gateway device were present in the network comprises configuring the reporting functionality such that reporting messages to the ephemeral gateway device are sent less frequently and/or with a different time pattern of the messages when the ephemeral gateway device is not present in the network than when the ephemeral gateway device is present in the network. For instance, when the ephemeral gateway device is not present in the network, the network can be configured by the configuration unit such that reporting messages are sent in times when a communication traffic of the network, i.e. between the network devices of the network, is low, in particular, below a predetermined threshold. This prevents the network from suffering a network latency caused by the reporting messages sent for the not present ephemeral gateway device. Generally, a network device sending a report at regular intervals can be informed, for instance, by a potential proxy for the ephemeral gateway device, that the ephemeral gateway device is not present in the network and can then be configured by the configuration unit to reduce the reporting frequency, preferably to zero.

In an embodiment, the configuration of the reporting functionality as if the ephemeral gateway device were present in the network comprises configuring the reporting functionality such that reporting messages to the ephemeral gateway device are stored when the ephemeral gateway device is not present in the network such that the stored reporting messages are provided to the ephemeral gateway device when joining the network. The stored reporting messages that are provided to the ephemeral gateway device can refer to all reporting messages sent since the last connection of the ephemeral gateway device with the network, to a subset of these sent reports, to the last N reporting messages before the joining, wherein N can be determined, for instance, by a user, to a summary or to a condensed form of the information in the reports, for example, a statistic over the information, etc. For instance, in such an embodiment, the configuration unit can be adapted to configure the network such that at least one of the network devices of the network receives all or some of the reporting messages and stores the reporting messages in its storage such that it can provide the reporting messages, for instance, as described above, to the ephemeral gateway device after the ephemeral gateway device has joined the network.

In an embodiment, the configuration unit is adapted to configure the network such that tasks carried out by one or more of the network devices of the network related to the management of the joining and remembering of the ephemeral gateway device are distributed between the network devices based on the network information. For instance, the network information can comprise device information indicative of device characteristics, like the storage capability, connectivity, etc., of the network devices of the network such that the configuration unit can be adapted to distribute a task related to the management of the joining and remembering of the ephemeral gateway device to the network devices most suitable for this task. Moreover, the network information can also comprise information on the location of the network devices, for instance, with respect to their surroundings, such that the configuration unit can be adapted to distribute the task related to the management of the joining and remembering of the ephemeral gateway device based on the information on the surroundings of the network devices. An exemplary application for such an embodiment is a case in which the network information comprises the information that one of the network devices is positioned near a door of a room such that it would be advantageous when the ephemeral gateway device could join the network via the network device near the door. In this example, it is also advantageous if the task related to the management of the joining and remembering of the ephemeral gateway device is also distributed mainly to the network device near the door. However, in another example, the task can also be spread through the network, i.e. provided by a plurality of devices, comprising devices distributed in a large area, like an open office, such that there is always a network device available that can manage a joining and remembering of the ephemeral gateway device. Moreover, based on their position in space some nodes can be excepted from providing this functionality, for instance, since they have to provide more important functionalities or are not suitable for such a task.

In an embodiment, the configuration unit is adapted to configure the network such that network devices are selected that can act as proxy when the ephemeral gateway device joins the network such that the ephemeral gateway device joins the network via one or more of the selected proxy network devices. A proxy can be regarded as a device that acts as an intermediary between the ephemeral gateway device and the network such that requests or messages from the ephemeral gateway device are sent to the network via the proxy and vice versa. The ephemeral gateway device can join the network via one of the selected proxy network devices or via more than one of the selected network devices. In particular, the configuration unit can be adapted to configure the network such that it is communicated to the ephemeral gateway device, whether it can join the network using one of the selected proxy network devices or using more than one of the selected proxy network devices. For, instance the configuration unit can be adapted to configure the network such that this information is provided to the ephemeral gateway device optionally together with rules for selecting and connecting to one or more of the selected proxy network devices. In particular, the configuration unit is adapted to configure the network by selecting the network devices that can act as proxy for the ephemeral gateway device based on the network information, for instance, based on device information being part of the network information. Moreover, the configuration unit can be adapted to configure the selected network device such that it can directly act as proxy. For instance, the selected network device can be configured as if the ephemeral gateway device were already in contact with the selected network device.

In a preferred embodiment, the configuration unit is adapted to configure the network such that an addressing information of the network is stored and maintained by the selected proxy network devices such that the addressing information of the network can be made available to the ephemeral gateway device when the ephemeral gateway device joins the network. The addressing information can refer to any addressing scheme used by the network for addressing specific network devices for sending and/or receiving messages. For instance, if the network refers to a Zigbee network, the addressing information can refer to the Zigbee address map. The addressing information then allows the ephemeral gateway device to directly communicate with the network devices without delay.

In a preferred embodiment, the configuration unit is adapted to configure the selected proxy network devices such that the ephemeral gateway device can communicate with a network by using the identity of the proxy network device over which the ephemeral gateway device joins the network, or such that the ephemeral gateway device can communicate with the network by replacing the network identity of the proxy network device over which it is connected to the network by its own network identity as long as the ephemeral gateway device is present in the network, or such that the ephemeral gateway device can communicate with the network using both an identity of the ephemeral gateway device and its own identity. The identity of the proxy network device in the network can refer, for instance, to the network address of the proxy network device in the network and the ephemeral gateway device can use this network address when communicating with the network. Thus, network devices other than the proxy network device do not have to learn additional network addresses for communicating with the ephemeral gateway device that can simply send messages to the ephemeral gateway device by using the network address of the proxy network device. In this case the ephemeral gateway device has the same permission as the proxy network device. Alternatively, the ephemeral gateway device can replace the identity of the proxy network device with its own network identity. This embodiment has the advantage that the ephemeral gateway device can be provided with a different set of permissions than the proxy network device which might be advantageous when the ephemeral gateway device should be used to configure the network in ways that the proxy network device is not allowed to do, or when the ephemeral gateway device should not be allowed to perform certain operations on the network, whereas the proxy network is allowed to perform these operations. Further, alternatively the ephemeral gateway device can communicate with the network using both an identity of the ephemeral gateway device and its own identity simultaneously, for instance, by using two network addresses which can be provided with different sets of permissions.

In an embodiment, the network configuration device further comprises a security unit, wherein the security unit is adapted to configure the network such that a security measure is in place for when the ephemeral gateway device wants to join the network. The security measure can be, for instance, a password that is requested by the ephemeral gateway device when the ephemeral gateway device wants to join the network. Moreover, the security measure can also refer to an identity of the ephemeral gateway device that is saved in the network such that the ephemeral gateway device first has to show that it matches this identity when it wants to join the network. Thus, with this embodiment it can be prevented that a non-authorized ephemeral gateway device can join the network and possibly use the permission of the authorized ephemeral gateway devices in the network.

In a further aspect of the invention, a network is presented, wherein a network comprises a plurality of network devices and having been configured by a network configuration device according to claim 1.

In another aspect of the invention, a network configuration method for configuring a distributed intelligence network to enable the network to work together with an ephemeral gateway device is presented, wherein the ephemeral gateway device is adapted to act as a gateway within the network when the ephemeral gateway device is present in the network, wherein during the configuration the ephemeral gateway device is absent from the network, wherein the network configuration method comprises the steps of:
providing network information indicative of characteristics of the network, wherein the network information is relevant for a gateway device for performing its tasks as a gateway in the network,
storing the network information such that the ephemeral gateway device can access the network information for the purpose of performing its task as a gateway for the network, and
configuring the network based on the network information such that the ephemeral gateway device can act as a gateway when present in the network, wherein the network is configured as if the ephemeral gateway device were present in the network.

In another aspect of the invention, a computer program for configuring the distributed intelligence network is presented, wherein the computer program comprises program code means for causing the network configuration device of claim 1 to carry out the steps of the method as defined in claim 14, wherein the computer program is executed by the network configuration device.

It shall be understood that the network configuration device of claim 1, the network of claim 13, the network configuration method of claim 14, and the computer program of claim 15, have similar and/or identical preferred embodiments, in particular, as defined in the dependent claims.

It shall be understood that a preferred embodiment of the present invention can also be any combination of the dependent claims or above embodiments with the respective independent claim.

These and other aspects of the invention will be apparent from and elucidated with reference to the embodiments described hereinafter.

### BRIEF DESCRIPTION OF THE DRAWINGS

In the Following Drawings:

FIG. 1 shows schematically and exemplarily an embodiment of a network of a plurality of network devices comprising a network configuration device, and

FIG. 2 shows a flowchart exemplarily illustrating an embodiment of a method for configuring a network.

### DETAILED DESCRIPTION OF EMBODIMENTS

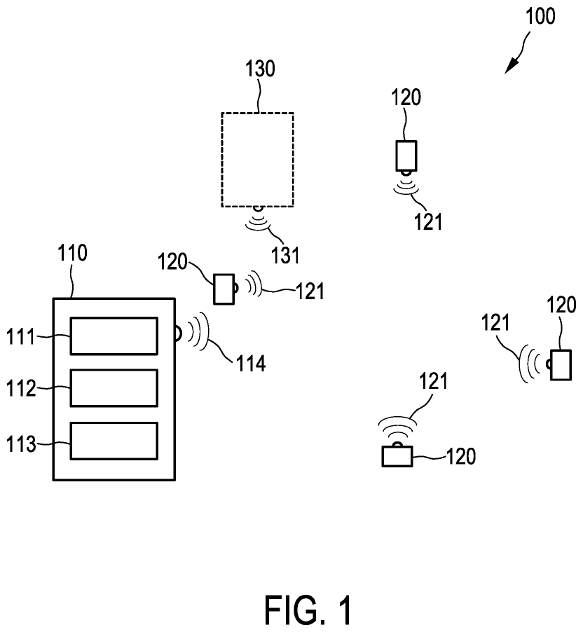

FIG. 1 shows schematically and exemplarily an embodiment of a network, in particular, a distributed intelligence network 100, with a plurality of network devices 120, wherein the distributed intelligence network 100 comprises a network configuration device 110. The distributed intelligence network 100 is formed by network devices 120 communicating with each other and maintaining the distributed intelligence network 100 via communication signals 121. The network devices 120 are preferably smart lighting devices, but can also refer to other smart devices with other functional capabilities. Generally, smart devices are regarded as devices that comprise in addition to their main functionality, for instance, their lighting functionality, additional functionalities, like network functionalities, communication functionalities, sensing functionalities, etc. Signals 121 are used for maintaining the network or for communication between the network devices 120. The network configuration device 110 is adapted to communicate with the network 100, in particular, with at least one of the network devices 120, by using wired or wireless communication signals 114. The network configuration device 110 can be a standalone device or can be integrated within one of the network devices 120 or can be integrated in another functional device that is adapted to communicate with at least one of the network devices 120. Preferably, the network configuration device 110 is part of a handheld device like a smartphone, a tablet computer or any other portable computation device.

Generally, the network configuration device 110 is adapted to configure the distributed intelligence network 100 to enable the network to work together with an ephemeral gateway device 130. The ephemeral gateway device 130 is not present during the configuration of the distributed intelligence network 100 as indicated by the dashed lines in FIG. 1. When the ephemeral gateway device 130 is present in the distributed intelligence network 100, it should act as a gateway for the distributed intelligence network 100 and can communicate, for instance, with the distributed intelligence network 100 via communication signals 131.

The network configuration device 110 comprises a network information providing unit 111, an information storing unit 112 and a configuration unit 113. The network information providing unit 111 is adapted to provide network information that is indicative of characteristics of the distributed intelligence network 100. In particular, the network information is relevant for the ephemeral gateway device 130 for performing its task as a gateway in the network. For instance, the network information can refer to access information to the distributed intelligence network 100, to network device information indicative of characteristics of at least one of the network devices 120, like functionalities, storing capabilities, communication capabilities, tasks in the network, local surroundings of the network device, network communication information like network addresses used for communication between the network devices 120, communication channels used for the communication, network protocols, etc.

The information storing unit 112 is then adapted to store the network information such that the ephemeral gateway device 130 can access the network information for the purpose of joining the network and performing its task as a gateway in the network. For instance, the information storing unit 112 can be adapted to store the network information in a virtual cloud storage provided by the owner of the distributed intelligence network 100. The ephemeral gateway device 130 can then be adapted to access the virtual cloud storage and the network information provided on the virtual cloud storage before joining the distributed intelligence network 100 but also during or after the joining of the distributed intelligence network 100. Accordingly, the information storing unit 112 can be adapted to store the network information, for instance, in a data format known to the ephemeral gateway device 130 or in a data format that is generally known for exchanging information between different devices, in particular, between network devices. Moreover, the information storing unit 112 can be adapted to store the network information in a storage location that can be provided to the ephemeral gateway device 130 either directly, for instance, via a communication between the network configuration device 110 and the ephemeral gateway device 130 at some point in time or indirectly, for instance, via a user having knowledge on the storage location of the network information and providing this knowledge to the ephemeral gateway device 130.

The configuration unit 113 is adapted to configure the distributed intelligence network 100 based on the network information provided by the network information providing unit 111 such that the ephemeral gateway device 130 can act as a gateway when present in the network. In particular, the configuration unit 113 is adapted to configure the distributed intelligence network 100 as if the ephemeral gateway device 130 were present in the distributed intelligence network 100. For example, the configuration unit 113 can configure the network 100 by configuring a reporting functionality of the distributed intelligence network 100 to the ephemeral gateway device 130 as if the ephemeral gateway device 130 were already present in the distributed intelligence network 100. Moreover, the configuration unit 113 can be adapted to configure the distributed intelligence network 100, for instance, by configuring at least one of the network devices 120 such that they can act directly as proxy device for the ephemeral gateway device 130 when the ephemeral gateway device 130 joins the distributed intelligence network 100. Other examples and embodiments for the configuration of the distributed intelligence network 100 provided by the configuration unit 113 will be explained in more detail in the following.

An exemplary application for the configuration device as described above is a case in which a lighting installer, e.g. an electrician, sets up a distributed intelligence lighting network, wherein then subsequently, weeks after the electrician has already left, a building manager arrives and wants to add his/her smartphone as ephemeral gateway device to the network. Since in this example the distributed intelligence lighting network does not comprise network devices, like smart lights, that have sufficient processing power to perform the tasks of a gateway, the gateway should virtually run on the facility manager's smartphone. Moreover, a facility manager is often not familiar with the installation software necessary for installing and configuring the network, but is more familiar with a management software which might include visualizations for management of the lighting functionalities of the network. In this case the lighting installer can use the configuration device being, for instance, part of its installation software and/or hardware to already configure the network to accept the smartphone of the facility manager running its own software as a temporary ephemeral gateway during the distributed intelligence lighting network is set up. In this case the lighting installer/electrician does not need to be physically present when the facility manager uses his/her smartphone as ephemeral gateway device. However, the network configuration device can comprise a security unit in this case that is adapted to add as a security element a consent required by the electrician which can be performed remotely via the installation software or cloud system. For instance, the consent may involve that the security unit is adapted to generate a temporary access code which is communicated to the ephemeral gateway device. This temporary access code can allow, for instance, the ephemeral gateway device to access the network information, like Zigbee network credentials, grouping of nodes and other relevant network information of the distributed intelligence lighting network from a cloud environment. Alternatively, the network information, like the Zigbee network credentials can be directly communicated to the ephemeral network device, for example, via SMS, email, etc.

In many applications more than one distributed intelligence network co-exists per building. Hence, depending on the whereabouts of the facility manager smartphone within the building, at a given moment a first network of the first floor can be connected to the smartphone as ephemeral gateway device, while a second network on the second floor is not connected to the ephemeral gateway device and continue operating in a standalone fashion. Hence, in such an embodiment a single smartphone can serve as an ephemeral gateway device to multiple independent distributed intelligence networks. Thus, a cumbersome and costly installation of an (IP-based) backbone connecting, for instance, multiple gateways on different floors via Ethernet cables can be omitted.

The above described network configuration device allows an ephemeral gateway device to smoothly join a network if the ephemeral gateway device, for instance, re-enters an area in which the distributed intelligence network is installed. For instance, the configuration unit can be adapted to configure network devices such that they can deal with an ephemeral gateway device which might “go away”, for instance, if the ephemeral gateway device is an iPad on a wall of a conference room that occasionally runs out of power, and can configure the distributed intelligence network either to forget about the ephemeral gateway device or to remember the ephemeral gateway device. Moreover, an upfront warning can be provided by the ephemeral gateway device to the network that the ephemeral gateway device starts or is about to disappear from the network. Moreover, the configuration unit can be adapted to configure a detection mechanism of at least one network device for detecting a re-appearance of the ephemeral gateway device and can be adapted to configure how a network device detecting the ephemeral gateway device shares this information with the other network devices in the network. Further, the network configuration device can be adapted to configure decision criteria for the joining of the ephemeral gateway device. For example, it can be configured whether or not to admit the ephemeral gateway device to the network or to use a collaborative mechanism such as a majority vote and/or arbitration between multiple ephemeral gateway devices. Thus, the above described embodiments allow an ephemeral gateway device, for instance, a smartphone as ephemeral gateway device, to seamlessly join the network at any moment after the installation of the network. In particular, the embodiments above describe how to implement an ephemeral gateway functionality for a distributed intelligence network without the ephemeral gateway device ever having been physically present in the network space, especially not during the installation of the network.

Generally, the configuration device configures the network devices right away as if the ephemeral gateway device, e.g. facility's manager smartphone which is not present during the setup of the distributed intelligence lighting network by the installer, is already part of the system. For instance, the information storing unit can be adapted to store network information, like network credentials, addresses, device info, grouping etc., in a virtual cloud storage for later use. The ephemeral gateway device can then access the network information in the virtual cloud storage and start working in the network right away when coming within reach. In an embodiment the configuration unit can additionally or alternatively be adapted to configure a reporting functionality of the network to the ephemeral gateway device which is currently not present in the building/area. In particular, the configuration unit can be adapted to add the reporting functionality to the network for later usage. This has the advantage that it can be avoided to add the reporting functionality when the ephemeral gateway device joins the network, which might lead to longer latency before the network can be controlled and/or data from the network are available to the ephemeral gateway device. The configuration of reporting functionality may include some functionality to keep the reporting alive during a period in which the ephemeral gateway device is not present in the network.

The configuration device can be adapted to perform different configurations of the reporting functionality. For example, the reporting functionality can be configured to switch data logging in the absence of the ephemeral gateway device. Alternatively or additionally, the reporting functionality can be configured to switch to a lower reporting frequency in the absence of the ephemeral gateway device. Moreover, the reporting functionality can be configured to stop the reporting, when the ephemeral gateway device is absent from the network. The reporting functionality can be configured by the configuration unit such that it is performed by employing broadcast messages to all other network devices, and, if present, thus also to the ephemeral gateway device. This has the advantage that the reporting will not fail when the ephemeral gateway device is not present in the network, as would be the case when using a unicast reporting to the ephemeral gateway device. Moreover, if a network device is configured to act as a proxy for the ephemeral gateway device, the reporting functionality can be configured to send all reports via unicast or broadcast to the proxy device. The proxy can then be configured by the configuration unit, to store the reports, a selection of the reports, or a summary/aggregation of the information of the reports, like a statistic over the information provided by the reports, depending on storage capabilities of the proxy device. The ephemeral gateway device could then readout this information from the proxy device when it connects.

The configuration unit can additionally or alternatively be adapted to install different networks in the same area, for instance, the same house or facility, to utilize a same radio frequency channel, for instance, if their respective spaces are in daily use linked to each other. This can ease the interaction of the ephemeral gateway device, for instance, the facility manager's smartphone, with the multiple networks simultaneously, if necessary.

In some applications, the configuration unit can be adapted to configure the network such that the identity, e.g. configurations or addresses, of the ephemeral gateway device is fixed. This might be advantageous when the ephemeral gateway device is a dedicated box or a gateway robot/drone which only once in a while is brought into the network, e.g. to change network configurations, check the network/device health or provide a software upgrade. In that case, the ephemeral gateway device can have its own IEEE address, short address, etc. and can use this address each time it joins the network.

In some other applications, e.g. in case of a smartphone connecting occasionally into a network using Bluetooth Low Energy connection through a proxy node, the ephemeral gateway device may be connected over a different proxy node each time. The configuration unit can, for instance, be adapted to configure the network such that the ephemeral gateway device can use the identity, e.g. address, device capabilities, etc., of a proxy network device over which it connects to the network. This embodiment is advantageous if the tasks to be performed by the ephemeral gateway device do not require any special permissions. Such general tasks may refer to adding some network devices to a distributed security network, changing reporting frequencies, bindings, configurations of sensors/switches, readout of device statistics, functionality control, like lighting control, etc. In this case when disconnecting the ephemeral gateway device from the network, only the information relevant for the gateway role remains in the network and not the information relevant for the hosting proxy network device. For instance, while all the network devices may stop reporting energy consumption once the ephemeral gateway device leaves, the proxy network device the ephemeral gateway device is connected to shall remain operational in the network, for example, so that it can still react to an occupancy detection in its area.

In an alternative embodiment, the configuration unit can be adapted to configure the network such that the ephemeral gateway device can replace the identity of the proxy network device it is connected to with its own identity at least in the part that is required for the tasks to be performed. For example, if the ephemeral gateway device is taking the task of a Trust Center, the network devices expect a Trust Center command to come from a particular address, e.g. IEEE address as stored before and short address 0x0000, and to be secured with a previously established Trust Center link key. The network configuration device can be adapted to provide such parameters to the proxy network device such that the ephemeral gateway device can utilize this information. In some embodiments, the proxy network device can be configured to take the address of the ephemeral gateway device. However, it can then not provide its functionalities to the network. For example, if an occupancy sensor is bound with the IEEE address of a lamp proxy node, but that address gets replaced with the Trust Center IEEE address used by the ephemeral gateway device, the lamp would stop responding to occupancy events for the duration of the ephemeral gateway device connection. However, such a situation can be prevented, if network information with respect to the configuration information relevant for the proxy network device is provided by the information storing unit such that the ephemeral gateway device can access this information. In some embodiments, at least part of this information may be stored on other network devices, like switches/sensors controlling a network device or Green Power proxies forwarding the Green Power communication to the network information. Alternatively or additionally, the information storing unit can be adapted to make this information available in a virtual cloud storage. The ephemeral gateway device can also be adapted to manipulate the information such that it reflects an identity that the ephemeral gateway device is going to use in the network, for instance, it can add a second unicast binding to a sensor controlling the proxy network device or can replace the existing one. The ephemeral gateway device can then switch identities with the proxy network device. Once all the ephemeral gateway device tasks are finished, the ephemeral gateway device may be adapted to revert the configuration it changed to its original state before it disconnects from the network. Moreover, the proxy device can also be configured to at least temporally act as two network devices, one comprising its own addressing and functions and as one with the addressing and functionality of the connected ephemeral gateway.

In an embodiment, for supporting an ephemeral gateway device when selecting a proxy for connecting to the network from the selected proxy network devices, the configuration unit can be adapted to configure the selected proxy devices to communicate information indicative on its usefulness to the ephemeral gateway device. For example, the selected proxy network devices can be adapted to send beacon messages comprising information on any of the following their status in the network, a number of neighboring network devices, an amount of stored network information or messages, etc. However, the ephemeral gateway device can also be configured to store information on the usefulness of the selected proxy network devices from a previous connection to the network and then base the decision on a connection on this information. Moreover, the ephemeral gateway device can simply connect to the same selected proxy network device each time. This allows, for instance, to reuse all the information and connection routines for this device each time. In particular, the configuration unit can be adapted to configure such a ‘favorite’ proxy network device for the network, for instance, by configuring the selected proxy network devices such that after one of the selected proxy network devices has connected to an ephemeral gateway device this selected proxy network device is indicated as the favorite selected proxy network devices for the ephemeral gateway device. In this case the network can be configured such that information for a specific ephemeral gateway device or another network that should be connected via the specific ephemeral device are always send and stored on the favorite proxy device of the ephemeral gateway device. Moreover, the configuration unit can be adapted to configure the network such that if an ephemeral gateway device wants to connect to the network only the corresponding favorite proxy device is available for the ephemeral gateway device.

In an embodiment, the ephemeral gateway device, for instance, provided as part of a smartphone, can comprise a dedicated proxy node of its own and it can be adapted to configure it appropriately for the network to be joined. In this way, the configurations of the network devices in the network remain unmodified and also any special means/interfaces, e.g. to read/write IEEE address and link key, can be omitted.

For many applications, it will be advantageous when the ephemeral gateway device can make use of a mesh network, i.e. can communicate with far-away network devices from one location. For instance, in a case in which the ephemeral gateway device performs a maintenance action of a network using a Zigbee communication protocol first a user can open a dedicated maintenance software on the ephemeral gateway device and then the ephemeral gateway device can be configured to start a Bluetooth Low Energy scan.

In a first scenario, it is assumed that the user does not know yet which of the potentially many found networks should be connected to so that he/she first sets the ephemeral gateway device to scan in the vicinity of the ephemeral network device. The ephemeral gateway device is then adapted to collect advertisements of combo radios of network devices in the vicinity, wherein a PAN-ID indicates if a network device is part of a network. The ephemeral gateway device is then adapted to present the results of the scan, for instance, network and node identifications, to the user, wherein the ordering can be random, but can preferably also refer to an ordering by RSSI, and/or by PAN-ID. The user can then select one network/network device provided in the report. The ephemeral gateway device is then configured to establish the Bluetooth Low Energy connection to that node. Thereafter the ephemeral gateway device is adapted in course of running the maintenance software to open an overview of the selected network, e.g. a list of network devices with status unknown, or with last known status and a timestamp.

In another scenario, the ephemeral gateway device automatically starts discovering the current status of all the network devices of a network, for instance, an on/off state or a brightness of a lighting network device. Alternatively, the status of the entire network or individual network devices can be discovered on demand. In another scenario, the ephemeral gateway device can be adapted to store static information about the network devices, for instance, information including active end points, simple descriptor, identities of device types, etc., so that this information does not need to be re-discovered.

In an example, the ephemeral gateway device can be adapted by using a list of the network devices to send a read attribute request (On/Off) to a network device using an IEEE address to identify the targeted network device. If that network device is no neighbor of the active proxy network device, that results first in a broadcast of a NWK_addr_req command—to find the network short address of the targeted network device—and second in a broadcast of a RREQ command (Route REQuest)—to find a route to the targeted network device from the proxy network device. If multiple network devices are queried in a short time, that may exceed the default Zigbee broadcast budget of e.g. 9 broadcasts in 9 sec. In this case the ephemeral gateway device can send a M2O RREQ command (Many-to-One Route REQuest), wherein then all the network devices in the network create a path back to it, but do not send the RREC command (Route RECord) reply yet, since this is only triggered by unicast communication. The ephemeral gateway device can then be adapted to read the NT (Neighbor Table) and/or the Address Map (AM) of the proxy network device, wherein the AM comprises a mapping of IEEE addresses to the network short addresses of devices in the network. However, in some cases the NT and/or the AM and/or routing table in the proxy devices can also be filled even before the proxy devices connects with the ephemeral gateway device (e.g. based on Link Status or other messages sent in the network, and/or actively sending messages by the proxy devices), wherein in this case the sending of the RREQ and/or NWK_addr_req command(s) by the ephemeral gateway device can be omitted and the NT and/or AM can be read directly by the ephemeral gateway device. Moreover, the ephemeral gateway device can be adapted to provide a source-routed message to each of the routers being neighbor of the active proxy network devices in turn asking for some useful status. Further, the network device can trigger a unicast RREC message or in case of neighbors of the proxy network device, can skip this trigger, since the destination, i.e. the proxy network device, is in its neighbor table. When the RREC message is received, the proxy network device or the ephemeral gateway device can be adapted to store an update of the source route. Further, the network device is adapted to send the unicast status response. The ephemeral gateway device is then adapted to read, for instance, by applying a source-routed unicast process, the NT of that particular network device and to store a list of the devices accessible at 2-hop distance. If network devices are accessible via multiple 1-hop neighbors, as visible in the neighbor's Link Status messages, the ephemeral gateway device can be adapted to select the one with the best LQI (Link Quality Indication). For extending this beyond the 2-hop distance, the Mgmt_LQI_req query can be sent to the network devices at a 2-hop distance to receive the list of their neighbors. For the devices at 2—and more hop distance the above described steps for receiving a useful status from the network devices can be repeated, to eventually gather data from all nodes in the network. Since the ephemeral gateway device is adapted to discover the network devices using topology information of the network, it can also use that information for storing the source routes in order to limit the amount of memory required. For example, for each device in the network the ephemeral gateway device can store the previous hop on the way to that network device so that the ephemeral gateway device is enabled to construct the entire source path. In this scenario, the ephemeral gateway device can be adapted to store the routing information for each network device only once, even though it will likely appear in the NT of multiple other network devices. For instance, the ephemeral gateway device can take the first occurrence of a network device or replace it with subsequent occurrences if the link cost to the subsequent neighbor is better.

As an alternative, the ephemeral gateway device can be adapted to store source routes from a previous connection to the network to send a M2O RREQ message and to then send the status requests in any order. The ephemeral gateway device can then be adapted to update the RREC as received.

As another alternative, the ephemeral gateway device can be adapted to store source routes and addresses of an active proxy network device from a previous connection to the network. In this case if the ephemeral gateway device connects to the network using a different access point, for instance, another configured proxy network device, the ephemeral gateway device can be adapted to recalculate the routes for the current access point. For example, the ephemeral gateway device is previously connected to proxy A, and it stores a route to B and D: A→B, A→D; and to C: A→B→C. If it now connects at D, it can recalculate the routes as: D→A, D→A→B; D→A→B→C, as a first approximation. The ephemeral gateway device can be adapted to then send a M2O RREQ message to send the status requests in any order and update the RREC as received. Further, the complete NT/network topology information can be stored rather than the source routes and first routes for any given location can be calculated. Another option is that the configuration unit has already selected and configured some preferred proxy network devices the ephemeral gateway device can connect to, as already described above. These selected proxy network devices can in particular be configured to continue maintaining routes even in the absence of the ephemeral gateway device. A connectedness status can be provided when the ephemeral gateway device discovers the preferred proxy network devices. However, a user of the ephemeral gateway device can still decide to connect to a non-preferred proxy network device, at the cost of additional delay related to route discovery. Once the current state of all/some network devices is known and the routes are established, they can be manually controlled/OTA upgraded/etc. using the ephemeral gateway device.

In some applications, it is also advantageous to clean up the routing to the ephemeral gateway device after the ephemeral gateway device has left the network. The configuration unit can be adapted to configure the network to follow the following exemplary routines for removing the many-to-one entry created by the active proxy network device. The network can be configured to first send a leave with rejoin message that should clean the network layer but not the application support layer and higher. However, this may lead to a possible disruption for Zigbee end devices and results in dissolving the entire network if the ephemeral gateway device has the task of a Trust Center. Moreover, this request is only communicated over a single hop.

Alternatively, the network can be configured such that the ephemeral gateway device assumes another short address for the time of a Bluetooth Low Energy connection and leaves that address once the connection is closed. However, in this case the ephemeral gateway device does not respond to unicast to its regular address and again the entire network is resolved if the ephemeral gateway device acts as a Trust Center.

Alternatively, the network, in particular the selected proxy network devices, can be configured for the time of the Bluetooth Low Energy connection to allow for two short addresses in parallel at the proxy network device, a regular short address and a short address for the proxy network device itself. For instance, a Zigbee Green Power protocol allows for sending from an additional address but not for receiving. In this case the configuration unit can be adapted to either extend the MAC address, store two addresses or turning the MAC address into promiscuous mode and filtering at a higher layer.

Alternatively, the configuration unit can be adapted to configure the network such that a new proprietary/standard command is defined that optionally announces a concentrator and closes a concentrator again, wherein the last message results in removing the M2O route to that device. Additionally, the configuration unit can be adapted to configure the network such that a new means is defined for indicating in the M2O RREQ message that a route to the ephemeral gateway device is temporary. In this case it can be configured that if the route is not be refreshed within a time period, it will be automatically removed by all the network devices storing it after a timeout without a need of a dedicated clean-up action. A refresh period for the M2O RREQ message can be defined as part of a communication standard, the network can be adapted to receive this parameter from the ephemeral gateway device or the network can be configured to provide the expected values for this parameter to the ephemeral gateway device.

Alternatively, the configuration unit can be adapted to configure the network such that a new proprietary/standard “temporary leave” command is defined to indicate that a device temporarily leaves the network. Optionally, the communicated temporary leave command can also comprise a reason for leaving and the expected absence duration. As a result, some information about that device can be removed, e.g. the routes, and other information can get marked as temporarily disabled/inactive, e.g. bindings, reporting, etc. Moreover, the information to be removed and temporarily disabled could be made part of the temporary leave command so that the leaving device can control what happens with that information. For example, if an ephemeral gateway device is likely to connect to the same proxy network device in the future, e.g. facility staff always entering the office wing coming from an elevator, the network can be configured to machine learn where in the network people connected to it with the mobile ephemeral gateway device and to deactivate rather than remove the information. If the ephemeral gateway device is likely to connect at a different proxy network device every time, the network can be configured to remove all of the information regarding the ephemeral gateway device. This configuration is preferred for cases in which the network is configured such that the ephemeral gateway device, if being a smartphone, uses its own identity rather than the identity of the proxy network device it connects through. As an extension, standard/proprietary means can be defined for a network device to indicate if it expects to join a network temporarily or permanently. An ephemeral gateway device can then be set to temporary. In this way other devices are instructed to treat the ephemeral gateway device also like a temporary device in a network, e.g. to not select it as a parent for a Zigbee end device or to avoid using it as an intermediate node when constructing routes if multiple next hops would be available resulting in the same cost, a permanent next hop could be preferred. Further, if a path cost through a permanent next hop would be slightly higher within defined threshold than a path through a next hop through a temporary device, then the higher-cost stable path could still be preferred, since it has a lower risk of needing rediscovery certainly due to temporary network device disappearance. As a further alternative, the configuration unit can configure the network such that a new network level routing command is defined for selectively removing a route.

An ephemeral gateway device per nature can appear at random access points in the network and is present/active in the network only at selected times, hence it may not have readily available routes for the network devices it needs to communicate with. Moreover, given the ephemeral nature of the ephemeral gateway device's presence in the network and the unknown location of rejoining the network the next time, the tasks related to enabling communication with the ephemeral gateway device, like addressing and routing, should have minimum impact on the network. In an embodiment, if Bluetooth Low Energy is used to connect from the ephemeral gateway device to network device with combined Bluetooth Low Energy and Zigbee capabilities in a network, the ephemeral gateway device is preferably able to connect to any of the network devices not a specific one. Thus, the configuration unit can be adapted to configure the network such that the ephemeral gateway device can use every time when connecting to the distributed intelligence lighting network another network device as proxy network device to get into the Zigbee network.

The presence/entrance of an ephemeral gateway device is preferably announced, e.g. a M2O RREQ is sent by the ephemeral gateway device, or by the proxy to which the ephemeral gateway device is connected on behalf of the ephemeral gateway device, to establish the routes to the ephemeral gateway device, and implicitly announcing the presence of the ephemeral gateway device to the network devices in the network. Moreover, it is preferred that the configuration unit configures the network such that network devices added to the network in the absence of the ephemeral gateway device performing the role of a TC, are configured to delay a TCLK update process until the gateway is present on the network. The announcing process as described above can then be used to trigger a start of this process.

Currently, the firmware update of networks, for instance, distributed intelligence lighting networks with many network devices utilizing a gateway device, is an issue for professional installers. Due to potential issues with the firmware update of large mesh networks, installers prefer to be present whenever an over-the-air update (OTAU) is performed. However, on many cases an OTAU is very time consuming, which causes idle waiting times for the installer. In this situation using an ephemeral gateway device can make sure that firmware updates are installed more reliably and quickly. For such an application the configuration unit can be adapted to configure network devices in the network to locally take the role of an interacting OTAU server for network devices in their immediate neighborhood. Moreover, the network can also be configured to use an “OTAU broadcast” command, since all/many network devices typically need the same code.

Smartphones acting as ephemeral gateway devices for OTAU purposes may be implemented in many forms. For example, a smartphone/tablet may be attached to a desk or wall of a conference room, wherein the conference room may feature a distributed intelligence network. The smartphone/tablet may run a gateway application virtually, for instance, an application displaying an ambient light effect synchronized to the content played on another device of the network. However, the smartphone/tablet needs to be regularly charged, which means that on occasions the tablet is out of power if, for instance, someone has disconnected the charger plugged into the tablet in the conference room, or a part of the building power supplying the tablet is switched off for maintenance reasons. Hence, the gateway is prone to disappear and hence the above described configuration device can be used to prepare, i.e. configure, the network accordingly.

The smartphone as ephemeral gateway device can also be attached to a cleaning cart of a housekeeping/maintenance staff, robotic vacuum cleaners or some devices carried by a security guard who has to walk all areas of the building regularly or implemented on a mobile device of one or more building occupants. This has the advantage that the ephemeral gateway device travels through a building on a regular basis and can thus read out or provide data to devices in all networks in the building regularly. The ephemeral gateway device can have a permanent or temporary data plan to connect with the outside world, for example, a 3G, 4G, 5G, etc. network connection, or Wi-Fi connection. In an example, the ephemeral gateway device can be adapted to utilize a wired connection for transmitting aggregated building data to a building management network or cloud server, when the ephemeral gateway device is securely docked/charging in a trusted facility management base station. The ephemeral gateway device can be adapted to operate one interface at a time, e.g. it can perform a first task via a facility manager application network, disconnect, perform whatever it was tasked with in a lighting control network and can leave the distributed intelligence lighting network again and, if required, re-connect to the building owner network again and report the results. The ephemeral gateway device, e.g. a smartphone, tablet or a laptop, can feature a Zigbee interface, e.g. built in or as a pluggable dongle. Alternatively, the ephemeral gateway device may be able to tunnel Zigbee traffic over another transport protocol, e.g. a Bluetooth Low Energy connection. A personal lighting control application running on a company smartphone used as ephemeral gateway device used by building occupants, e.g. employees of a tenant, for instance, to control lighting in the meeting room, can under the control from a cloud, for example, of a vendor and/or facility management, be extended to provide additional tasks/modules, e.g. a real-time clock update, an OTAU, a schedule reconfiguration, collecting maintenance data from a particular room, etc. These tasks could be done by the company-issued phone as ephemeral gateway device completely invisibly to the smartphone user to avoid user interfering with the maintenance. Certain functions, e.g. resetting of the ephemeral gateway device, or even phone functions, e.g. switching off, could be temporarily blocked. To make sure that the information provided or collected by that ephemeral gateway device can be trusted, even if the ephemeral gateway device itself cannot be trusted, the information could be protected in such a way that it cannot be manipulated by the ephemeral gateway device itself, e.g. the information can be encrypted or signed. This could be the main ephemeral gateway device operation mode or an “emergency mode”, e.g. when urgent security fixes need to be applied to the network. Depending on a selected operation mode and an urgency of an update, additional behavior can be activated when the user starts the basic function of the ephemeral gateway device or the ephemeral gateway device can be activated under cloud control as a background process.

In the case of a distributed ephemeral gateway, it is advantageous if network coverage is assured. The ephemeral gateway device can be configured to report to a virtual cloud storage about standalone networks/devices it detects in its vicinity. The virtual cloud storage can then be configured to check if there are any pending tasks, for instance, data provisioning/read-outs for those detected devices and, if required, instruct the ephemeral gateway device to perform certain actions on certain networks/devices. Alternatively, the network configuration device can configure the network to define the networks/devices and tasks a particular ephemeral gateway device is responsible for. This can, for instance, be based on typical movement or control patterns of the ephemeral gateway device, e.g. being stationed at an employee's desk location, etc. To assure full coverage, dedicated users can be sent to areas not frequented by employees or not yet updated such that a quick implementation of security critical software updates to all devices in the network is ensured.

For efficiency, the update/maintenance action can be a hybrid solution. For example, rather than addressing all the network devices on a particular network, the ephemeral gateway device can update the software of one particular network device on that network, e.g. via OTAU or piecemeal configuration software addition/removal. The configuration unit can be adapted to configure the network such that this network device can further distribute the software image and/or information in its network and collect the status thereof or e.g. collect status and maintenance data from the network such that a report is ready when the ephemeral gateway device connects again.

The installer of the distributed intelligence network can, in addition to configuring the network devices of the network for the network and control operations, use the network configuration device being part of his/her installation device to configure at least one network device for a subsequent integration with other ephemeral gateway devices such as the facility manager's maintenance application running on the building owner's smartphone.

Each such ephemeral gateway device can have at least one of the following tasks as part of its gateway function (i) a connection function, wherein it connects the network interface of a first network to a second network, for instance, it provides a Zigbee-Bluetooth Low Energy interface between the smartphone of the user and a network device, and/or (ii) a control function, wherein it is responsible for controlling the data flow between the two interfaces, e.g. for aggregating or filtering data exposed by the first network and filtering, addressing correctly or blocking queries and commands coming from a second network. For example, in the case of the Zigbee to Bluetooth Low Energy interface the selected ephemeral gateway device can, in addition to/instead of any services it vendor installed on it, be programmed with the Bluetooth Low Energy service of the second network so that it can be discovered and used by the second network.

Managing the joining and remembering of ephemeral gateway devices requires some processing resources within the distributed intelligence network. Typically, all network devices, for instance, in a distributed intelligence lighting network, are resource constrained. Hence, the network configuration device connecting to the distributed intelligence network can be adapted to inventorize the network devices present in the network as part of the network information and then for configuring the network to assign tasks related to ephemeral gateway management to the network devices. Once the configuration device is gone, the network devices can pick up their tasks. Due to its processing power, the configuration device that can be part of a first ephemeral gateway device connecting to the network is adapted to allocate the processing in a fool proof way across the network devices. Hence, within the network itself no arbitration process and central orchestration is required.

The configuration unit can be adapted to configure the network such that a proxy function is implemented as a shared function in some or all network devices based on network information. For instance, the network information can indicate that storing the entire network information may be too much for one node due to memory/processing concerns but that it is possible for different network devices to cooperate such that neighboring nodes each can store a part of the network information. The configuration unit can then be adapted to configure the network accordingly. The ephemeral gateway device can then connect to each of those network devices comprising part of the network information one-by-one to quickly retrieve the complete network information. Setting up the distribution of network information between the network devices by the configuration unit can be set up during commissioning or upon first contact of an ephemeral gateway device comprising the configuration device with the network.

Moreover, the configuration device can be adapted to configure the network such that each network device stores at least a part of the network information, e.g. by using some numeric relation between the network devices. For example, a network device with a MAC address ending with a binary code of 000 can store the information for all network devices in the network with a MAC address ending with a binary code of 000. In this way, each network device stores only ⅛ of the network information, which allows to also include network devices with a low storage capability. In this example, the ephemeral gateway device can connect to 8 network devices to get the full network information needed. Based on a known numerical relation the ephemeral gateway device can deduce in which order the 8 network devices to connect to. The ephemeral gateway device can be adapted to first connect to a network device with an address ending with binary code of 000, then to connect to a network device with an address ending with binary code 001, etc. Alternatively, the ephemeral gateway device can be adapted to connect to one network device, wherein the network device is configured by the configuration unit such that in this case it collects the data it does not have itself from neighboring network devices.

In an example, the network can be adapted to use a Zigbee communication protocol for communicating and maintaining the network. In the Zigbee protocol two types of network addresses are used, an 8 Byte IEEE address as MAC/Long Address for a network device that is fixed over its lifetime and a 2 Byte network address as Short Address that is obtained upon joining the network and can be changed, for instance, when an address conflict has to be solved. The configuration device can be adapted to store network information, for instance, in a cloud or even in the ephemeral gateway device, e.g. as configuration backup. In particular, as network information an IEEE address for unicast communication with the network devices can be stored, because it is fixed. Additionally or alternatively, also group network addresses for groupcast communication can be stored as network information. However, when utilizing a Zigbee protocol for unicast communication a network address of the destination is needed. Generally, in the Zigbee protocol a map of the IEEE addresses to network addresses for all network devices is maintained. Thus, the ephemeral gateway device can utilize this map for accessing the information on the network addresses. In particular, if a higher layer requests unicast communication with an IEEE address for which the network address is not known, the Zigbee protocol indicates to discover the network address by sending broadcast a NWK_addr_request communication.

Especially in the case when it is requested that an ephemeral gateway device communicates quickly with a larger number of devices, e.g. to obtain a current status of the network, the above possibility results in multiple broadcast messages which may result in serious network clogging and/or delay. Thus, the network configuration device can be adapted to store the mappings of the addresses as network information such that the ephemeral gateway device can access this information directly, for instance, by accessing a virtual cloud storage, or a network device storing. In this embodiment, the network configuration device can be adapted to store the address mapping of all network devices in a storage of a selected proxy network device by which the ephemeral gateway device can connect to the network. Alternatively, if the address mapping is too large for the network configuration device, this data can be stored, as described already above, also on multiple network devices. In particular, based on the network information the configuration unit can be adapted to determine which network device comprises storage capabilities allowing the network device to store a proxy address map with the addresses for the entire network and to select such a network device as proxy network device. Moreover, in a case in which at least one network device comprises in addition to the Zigbee communication capability a Bluetooth Low Energy communication capability the network configuration device can be adapted to configure the network device such that, if it is a direct neighbor of the selected proxy network device, to communicate a current short address to the ephemeral gateway device over Bluetooth Low Energy without any Zigbee communication involved. Additionally or alternatively, the network configuration device can be adapted to configure the network such that a selected proxy network device and/or all network devices keep track of all long/short address mappings, for instance, by broadcasting all changes to the network devices and/or monitoring routing-related messages being sent on the network by other devices. The network can then be configured, for instance, as an application function to share this network information with the ephemeral gateway device over Bluetooth Low Energy when the ephemeral gateway device connects to the network. Further, the network and/or the ephemeral gateway device can be configured to check whether the network information provided by the virtual cloud storage or by at least one of the network devices is correct, for instance, up to date. For instance, the configuration device can be adapted to configure the network device such that it is ensured that a tunnel service characteristic, for example, used for pushing Zigbee frames straight from ephemeral gateway device through a Bluetooth Low Energy connection with the proxy network device, uses unicast for providing both addresses for the current communication partner, i.e. network device. Moreover, in order to make sure that addresses provided, for instance, by a virtual cloud storage are up to date, the ephemeral gateway device can be adapted to send a unicast IEEE_addr_req communication to a network address before using it. However, such checks can also be omitted if it is expected that address changes are seldom, for instance, if the configuration device is not present anymore and no devices are being added to the network. If in this case a change occurred such that the address information is not correct anymore, the communication of the ephemeral gateway device with a network device can fail. The ephemeral gateway device can then be adapted to react as known in such situations.

In an embodiment, the configuration device can be adapted to configure the network such that each selected proxy network device stores address information, like the Zigbee address map, for the complete network. In this case the configuration device can be adapted to use the network information to determine which network devices have the respective capabilities. Generally, for instance, for a Zigbee protocol, network devices only store the address information of network devices they communicate with, for example, coordinator devices, bound devices, neighbor routers, Zigbee End Devices, children devices, etc. Thus, the configuration unit can be adapted to configure the network to provide a dedicated function that can always run on the selected proxy network device, i.e. that runs not only when the ephemeral gateway device is connected, wherein the dedicated function is adapted to store and update the address information. For example, the function can be configured to utilize device announce (Device_annces) and RREQ commands and/or active network discovery at least at the beginning of the network. Depending on which network devices are selected as proxy network devices, all selected network devices can be configured to run such a function. In particular, if all network devices of a network are selected as proxy network devices, all network devices of the network can run this function.

In an embodiment, only one proxy network device is selected by the configuration unit for connecting with the ephemeral gateway device. In this case the ephemeral gateway device always connects via that one selected proxy network device. The configuration device can then be adapted to configure in particular the selected proxy network device to be ready to work together with the ephemeral gateway device. For example, the selected proxy network device can be configured to maintain an up to date address information. The information storage unit can be adapted to store as network information address information, for instance, a Bluetooth Low Energy and/or Zigbee address, of the selected proxy network device in a virtual cloud storage or other location such that the ephemeral gateway device can access it. Potentially this information can also be stored in relation to the other network devices in a network area, for example a radio range of the selected network device so that a user, for instance, a maintenance staff, can be guided, e.g. with light effects, to get in the vicinity of selected proxy network device. For example, an ephemeral gateway device of a user can be adapted to make use of a floor plan in order to guide a user to the selected proxy network device, for instance, by instructing the user to get close to a window, by guiding the user with Bluetooth Low Energy beacons emitted by a regular grid of network devices in a certain direction, etc. In an embodiment, the network can be configured to allow the ephemeral gateway device to initially connect to any network device in the network, wherein the ephemeral gateway device can then be adapted to send a broadcast command requesting the selected proxy network device to identify itself. Sending such a message as a broadcast overcomes all addressing problems and the need for reverse path to send any responses.

Generally, the configuration unit can be adapted to utilize network information for selecting possible proxy network devices. For instance, a type of the network device can be utilized as network information. In an example, the proxy function can be implemented in a network device type in the network with a lower count than other device types, e.g. the room's wall switch network device can be selected rather than a lighting network device. In such an example, the storage unit can be adapted to store as network information the network device type such that the ephemeral gateway device can access it and knows, for instance, that it needs to connect to a light switch device as proxy network device rather than one of the lighting network devices. After the configuration, the ephemeral gateway device can be made aware of the storage location and can, for instance, download a list of selected proxy network devices or types of devices it can connect to within the network. Based on the network information, for instance, the location information on network devices, the configuration unit can be adapted to select the proxy network devices such that a sufficient density of such devices is provided at any location in the building. Alternatively, the network can be configured to provide the information on the proxy network devices or the types of network devices that should be connected to via Bluetooth Low Energy, e.g. a proxy network device can add a flag in its announcements indicating it can be used as a proxy network device by the ephemeral gateway device, and/or via Zigbee communication, e.g. the ephemeral gateway device can connect to any network device and is then provided with the information on which network device is a selected proxy network device or comprises proxy capabilities for the task it needs to perform.

In an embodiment, the ephemeral gateway device can be adapted to discover the network information itself, for instance, to check for address updates, etc., when joining the network. To make the update bearable for the user, the ephemeral gateway device can be adapted to show a progress of network updates, for example, with nodes to be checked grayed out and nodes already checked and available for communication visible as such. The user could already start some actions on the nodes already checked. Moreover, the network can be configured such that some operations, e.g. controlling all the lights of a group or controlling a set of lights using groupcast assuming the group-id's are known a priori to the ephemeral gateway device, can be performed as soon as the connection with the proxy network device has been established. This can be in particular such operations that do not require, for instance, route discovery or listing of used short addresses in the network.

Generally, a proxy network device keeps the addresses of network devices that it communicates with up to date as part of normal operation of the communication protocol, for instance, the Zigbee protocol. Thus, optionally, information on a number of addresses maintained by a network device can be part of the network information and the configuration unit can be adapted to select a network device as proxy network device that maintains the most addresses or maintains a number of addresses above a predetermined threshold, e.g. network devices in the middle of a room/zone surrounded by many network devices can be preferred over network devices at the network edges. Optionally, the network can be configured by the configuration unit such that the number of maintained addresses is made available to the ephemeral gateway device, e.g. as part of Bluetooth Low Energy beacon, and can be explicitly taken into account by the ephemeral gateway device for the selection of the network device used as proxy.

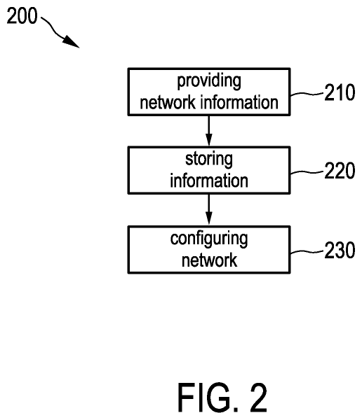

FIG. 2 illustrates schematically and exemplarily a network configuration method for configuring a distributed intelligence network, like the distributed intelligence network 100, in order to enable the distributed intelligence network to work together with an ephemeral gateway device, like ephemeral gateway device 130. The network configuration method 200 comprises a first step 210 of providing network information indicative of characteristics of the distributed intelligence network 100, wherein the network information is relevant for the gateway device 130 for performing its task as a gateway in the network 100. In step 220, the provided network information is stored such that the ephemeral gateway device 130 can access the information for the purpose of performing its task as a gateway for the network. For instance, the network information can be stored in this step in accordance with one of the above described embodiments. Further, in step 230, the distributed intelligence network 100 is configured based on the network information such that the ephemeral gateway device 130 can act as a gateway when present in the network. In particular, the distributed intelligence network 100 is configured as if the ephemeral gateway device 130 were present in the network. For instance, the distributed intelligence network can be configured during this step in accordance with one of the above described embodiments. Generally, during all steps 210, 220 and 230, the ephemeral gateway device 130 is not part of the distributed intelligence network or might not even be present in the vicinity of the distributed intelligence network 100.

Although the above described embodiments mainly provide details on embodiments where the network utilizes a Zigbee communication protocol, the embodiments can also be used with other communication protocols, wherein then respective communication functions of these protocols can be used instead of the Zigbee functions.

Although the above described embodiments mainly provide details on embodiments where the network refers to a distributed intelligence lighting network, i.e. a network comprising mainly lighting devices and providing mainly lighting functions, the described embodiments can also be adapted to networks with other functionalities, for instance, entertainment functionalities, home or office management functionalities, etc.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Procedures like the providing of network information, the storing of the network information, or the configuration of the network, performed by one or several units or devices can be performed by any other number of units or devices. For instance, these procedures can be carried out by a single device or by a plurality of different devices. These procedures can be implemented as program code means of a computer program and/or as dedicated hardware.

A computer program may be stored/distributed on a suitable medium, such as an optical storage medium or a solid-state medium, supplied together with or as part of other hardware, but may also be distributed in other forms, such as via the Internet or other wired or wireless telecommunication systems.

Any reference signs in the claims should not be construed as limiting the scope.

The invention refers to a network device for configuring a network to enable the network to work with a gateway device, wherein the gateway device is adapted to act as gateway within the network when the gateway device is present in the network, wherein during the configuration the gateway device is absent from the network. The network device is adapted to provide information indicative of characteristics of the network and relevant for a gateway device, to store the information such that the gateway device can access the information, and to configure the network based on the information such that the gateway device can act as a gateway when present in the network, wherein the network is configured as if the gateway device were present in the network. Thus, the utilizing of a gateway device not used for the installation of the network can be simplified.

The invention claimed is:

1. A network configuration device for configuring a distributed network, comprising a plurality of network devices, to enable the network to work together with an ephemeral gateway device, wherein the ephemeral gateway device is adapted to act as a gateway within the network when the ephemeral gateway device is present in the network, wherein the network configuration device comprises:
a network information providing unit for providing network information indicative of characteristics of the network, wherein the network information comprises (i) device information indicative of characteristics and/or location of at least one of the network devices and/or (ii) access information to the distributed network,
an information storing unit for storing the network information such that the ephemeral gateway device can access the network information for the purpose of performing its task as a gateway for the network, and
a configuration unit for configuring the network, while the ephemeral gateway device is absent from the network, based on the network information such that the ephemeral gateway device can act as a gateway when present in the network, wherein the network is configured as if the ephemeral gateway device were present in the network by preparing one or more of the network devices of the plurality of network devices to allow contact of an ephemeral gateway device and/or by configuring a security measure of the network such that an ephemeral gateway device is allowed to join the network.

2. The network configuration device according to claim 1, wherein the information storing unit is adapted to store the network information in a virtual cloud storage such that the ephemeral gateway device can access the information in the virtual cloud storage for the purpose of joining the network.

3. The network configuration device according to claim 1, wherein the information storing unit is adapted to store at least network information that is different from the data necessary for the ephemeral gateway device to access the network on at least one network device of the network.

4. The network configuration device according to claim 3, wherein the information storing unit is adapted to store the network information by distributing the network information to different network devices, of the plurality of network devices, based on the network information.

5. The network configuration device according to claim 1, wherein the configuration unit is adapted to configure a reporting functionality of the network such that the network carries out the reporting functionality as if the ephemeral gateway device were present in the network.

6. The network configuration device according to claim 5, wherein the configuration of the reporting functionality as if the ephemeral gateway device were present in the network comprises configuring the reporting functionality such that reporting messages to the ephemeral gateway device are sent less frequently and/or with a different time pattern of the messages when the ephemeral gateway device is not present in the network than when the ephemeral gateway device is present in the network.

7. The network configuration device according to claim 5, wherein the configuration of the reporting functionality as if the ephemeral gateway device were present in the network comprises configuring the reporting functionality such that reporting messages to the ephemeral gateway device are stored when the ephemeral gateway device is not present in the network such that the stored reporting messages are provided to the ephemeral gateway device when joining the network.

8. The network configuration device according to claim 1, wherein the configuration unit is adapted to configure the network such that tasks carried out by one or more of the network devices, of the plurality of network devices, related to the management of the joining and remembering of the ephemeral gateway device are distributed between the network devices based on the network information.

9. The network information device according to claim 1, wherein the configuration unit is adapted to configure the network such that network devices, of the plurality of network devices, are selected that can act as proxy when the ephemeral gateway device joins the network such that the ephemeral gateway device joins the network via one of the selected proxy network devices.

10. The network configuration device according to claim 9, wherein the configuration unit is adapted to configure the network such that an addressing information of the network is stored and maintained by the selected proxy network devices such that the addressing information map of the network can be made available to the ephemeral gateway device when the ephemeral gateway device oins the network.

11. The network configuration device according to claim 9, wherein the configuration unit is adapted to configure the selected proxy network devices such that the ephemeral gateway device can communicate with a network by using the identity of the proxy network device over which the ephemeral gateway device joins the network, or such that the ephemeral gateway device can communicate with the network by replacing the network identity of the proxy network device over which it is connected to the network by its own network identity as long as the ephemeral gateway device is present in the network, or such that the ephemeral gateway device can communicate with the network using both an identity of the ephemeral gateway device and its own identity.

12. The network configuration device according to claim 1, wherein the network configuration device further comprises a security unit, wherein the security unit is adapted to configure the network such that a security measure is in place for when the ephemeral gateway device wants to join the network.

13. A network comprising a plurality of network devices and having been configured by a network configuration device according to claim 1.

14. A network configuration method for configuring a distributed network, comprising a plurality of network devices, to enable the network to work together with an ephemeral gateway device, wherein the ephemeral gateway device is adapted to act as a gateway within the network when the ephemeral gateway device is present in the network, wherein the network configuration method comprises the steps of:
providing network information indicative of characteristics of the network, wherein the network information comprises (I) devices information indicative of characteristics and/or location of at least one of the network devices and/or (II) access information to the distributed network,
storing the network information such that the ephemeral gateway device can access the network information for the purpose of performing its task as a gateway for the network, and
configuring the network the ephemeral gateway device is absent from the network, based on the network information such that the ephemeral gateway device can act as a gateway when present in the network, wherein the network is configured as if the ephemeral gateway device were present in the network by preparing one or more of the network devices of the plurality of network devices to allow contact of an ephemeral gateway device and/or by configuring a security measure of the network such that an ephemeral gateway device is allowed to join the network.

15. A computer program for configuring the distributed network, wherein the computer program comprises program code means for causing the network configuration device of claim 1, wherein the computer program is executed by the network configuration device.
